(19) United States
(12) Patent Application Publication
(10) Pub. No.: US 2016/0188710 A1
(43) Pub. Date: Jun. 30, 2016

(54) METHOD AND SYSTEM FOR MIGRATING DATA TO NOT ONLY STRUCTURED QUERY LANGUAGE (NoSOL) DATABASE

(71) Applicant: Wipro Limited, Bangalore (IN)

(72) Inventor: Pandurang Dulba Naik, Pune (IN)

(21) Appl. No.: 14/634,150

(22) Filed: Feb. 27, 2015

(30) Foreign Application Priority Data
Dec. 29, 2014 (IN) 6647/CHE/2014

(51) Int. Cl. G06F 17/30

(52) U.S. Cl. CPC G06F 17/30705; G06F 17/303; G06F 17/30294; G06F 17/30619

(57) ABSTRACT

A method, non-transitory computer readable medium, and data migration computing device that retrieves database metadata information, query statements information and query scripts information of each of database tables from relational database system. Then, query patterns of each of database tables from query statements information and query workload of each of database tables from the query scripts information is identified. Next, table key information and table index information of each of the database tables based on correlation between the database metadata information and the query patterns of corresponding database tables is determined Then, data model of a Not Only Structured Query Language (NoSQL) database is generated using database metadata information, the query patterns, query workload, table key information and table index information. Then, data model of NoSQL database is verified. Lastly, data from relational database is migrated to NoSQL database.

This application claims the benefit of Indian Patent Application No. 6647/CHE/2014 filed Dec. 29, 2014, which is hereby incorporated by reference in its entirety.

### TECHNICAL FIELD

The present subject matter is related, in general to the field of databases and more particularly, but not exclusively to a method and system for migrating data from relational databases to Not Only Structured Query Language (NoSQL) databases.

### BACKGROUND

Generally, one or more establishments use relational database system which is known as Relational Database Management System (RDBMS) for storing data. The one or more establishments include, but are not limited to, commercial establishments, service provider organization, social network servers, social media servers, data security centers, industries and the like. Typically, the RDBMS use relational data model which describes a manner in which the data can be stored in the RDBMS and accessed from the RDBMS. In particular, the primary objective of the relational data model is to provide a definition and format of data which can be manageable and processed by the RDBMS. The RDBMS stores the data into one or more tables of rows and columns. In such a way, the data is stored in structured fashion which facilitates the one or more establishments to access the data from RDBMS effortlessly.

However, there exists a problem to use the traditional RDBMS for storage of data when the size or volume of the data is huge, usually referred as Big Data. In other words, the RDBMS can store limited size of data and therefore the Big Data is not manageable in the traditional RDBMS. Further, the relational database is restricted to store Structured Query Language (SQL) based data. Therefore, any data which are not SQL based are not manageable and/or storable in the relational database.

Conventionally, one or more methods are carried out to transform the relational data model into other data model as per the kinds of database required by the one or more establishments. For example, the relational data model is transformed into a non-relational data model (e.g. Not Only Structured Query Language (NoSQL)) when the one or more establishments require using a non-relational database system. However, there exists a problem in the existing one or more methods in transforming the relational data model into the predefined data model. For example, there exists an architectural difference between the relational database system and the non-relational database system. In such a case, there exists a challenge in transforming the architecture of the relational data model into the architectural requirements of the non-relational data model. There exists a challenge in transforming the relational data model into the NoSQL data model when the relational data model comprises schema less data model, and/or which involves performance differences. Also, a problem arises in transforming the relational data model into the NoSQL data model when the relational data model is created based on query patterns rather than entity relationships.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein is a method for migrating data from a relational database to a Not Only Structured Query Language (NoSQL) database. The method comprises one or more steps which are performed by a migration system. First step of the method comprises retrieving at least one of database metadata information, query statements information and query scripts information of each of database tables from a relational database system. Second step of the method comprises identifying at least one of query patterns of each of database tables from the query statements information and query workload of each of the database tables from the query scripts information. Third step of the method comprises determining at least one of table key information and table index information of each of the database tables based on correlation between the database metadata information and the query patterns of corresponding database tables. Fourth step of the method comprises generating a data model of the NoSQL database using at least one of the database metadata information, the query patterns, the query workload, the table key information and the table index information. The method further comprises generating the data model of the NoSQL database by performing two acts. First act comprises generating a logical data model comprising at least one of the database metadata information, the query patterns and the table key information. Second act comprises generating a physical data model comprising at least one of details of data type of columns and attributes, and the table index information, using the logical data model. Fifth step of the method comprises verifying the data model of the NoSQL database. Last step of the method comprises migrating data from the relational database to the NoSQL database. The method further comprises updating the at least one of the logical data model and the physical data model based on update information received from a user. The method further comprises verifying the data model of the NoSQL database comprises verifying presence of the table key information, details of data type of columns and attributes and the table index information in the data model. The method comprises providing an alert upon determining the verification to be unsuccessful. The method comprises verifying migration of the data from the relational database to the NoSQL database.

In an aspect of the present disclosure, a migration system for migrating data from a relational database to a Not Only Structured Query Language (NoSQL) database. The migration system comprises a processor and a memory communicatively coupled to the processor. The memory stores processor-executable instructions, which, on execution, cause the processor to retrieve at least one of database metadata information, query statements information and query scripts information of each of database tables from a relational database system. The processor configured to identify at least one of query patterns of each of database tables from the query statements information and query workload of each of the database tables from the query scripts information. The processor is configured to determine at least one of table key information and table index information of each of the database tables based on correlation between the database metadata information and the query patterns of corresponding database tables. The processor is configured to generate a data model of the NoSQL database using at least one of the database metadata information, the query patterns, the query workload, the table key information and the table index information.

The processor is configured to generate the data model of the NoSQL database by performing two acts. The processor performs first act to generate a logical data model comprising at least one of the database metadata information, the query patterns and the table key information. The processor performs second act to generate a physical data model comprising at least one of details of data type of columns and attributes, and the table index information, using the logical data model. Then, the processor is configured to verify the data model of the NoSQL database. Last step of the method comprises migrating data from the relational database to the NoSQL database. The processor is further configured to update the at least one of the logical data model and the physical data model based on update information received from a user. The processor is further configured to verify the data model of the NoSQL database by performing verifying presence of the table key information, details of data type of columns and attributes and the table index information in the data model. The processor is further configured to provide an alert upon determining the verification to be unsuccessful. The processor is further configured to verify the migration of the data from the relational database to the NoSQL database.

In another aspect of the present disclosure, a non-transitory computer readable medium for facilitating network connectivity is disclosed. The non-transitory computer readable medium includes instructions stored thereon that when processed by a processor causes a first computing device to perform one or more acts. The act comprises retrieving at least one of database metadata information, query statements information and query scripts information of each of database tables from a relational database system. Then, at least one of query patterns of each of database tables from the query statements information and query workload of each of the database tables from the query scripts information is identified. Next, at least one of table key information and table index information of each of the database tables is determined based on correlation between the database metadata information and the query patterns of corresponding database tables. Then, a data model of the NoSQL database is generated using at least one of the database metadata information, the query patterns, the query workload, the table key information and the table index information. The act comprises generating a logical data model comprising at least one of the database metadata information, the query patterns and the table key information. The act comprises generating a physical data model comprising at least one of details of data type of columns and attributes, and the table index information, using the logical data model. Then, the data model of the NoSQL database is verified. Last act comprises migrating data from the relational database to the NoSQL database. The act further comprises updating the at least one of the logical data model and the physical data model based on update information received from a user. The act further comprises verifying the data model of the NoSQL database by performing verifying presence of the table key information, details of data type of columns and attributes and the table index information in the data model. The alert is provided upon determining the verification to be unsuccessful. Then, the data from the relational database to the NoSQL database is migrated. Also, the act comprises verifying the migration of the data from the relational database to the NoSQL database.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows exemplary block diagram illustrating a migration system with processor and memory for migrating data from a relational database to a Not Only Structured Query Language (NoSQL) database in accordance with some embodiments of the present disclosure;

FIG. 2 shows a detailed block diagram illustrating a migration system with various modules for migration data from a relational database to a NoSQL database in accordance with some embodiments of the present disclosure;

FIGS. 3a and 3b illustrate a chart showing query workload of relational database in accordance with some embodiments of the present disclosure;

FIG. 4 illustrates a flowchart of method for migrating data from a relational database to NoSQL database in accordance with an embodiment of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method for migrating data from relational database to Not Only Structured Query Language (NoSQL) database. The present disclosure performs migration of the data upon transforming a relational data model of the relational database into a NoSQL data model. The method accesses one or more information of the relational database to transform the relational data model into the NoSQL data model. The one or more information includes, but is not limited to, metadata information, query statements, query patterns, query scripts, workload of query operations, keys and indexes of the relational database. After transforming, the NoSQL data model is verified whether all the one or more information of the relational data model is transformed into the NoSQL data model. After verification, the data from the relational database is migrated to the NoSQL database. Further, a verification is performed to check whether all the data from the relational database is migrated to the NoSQL database in order to identify the missing of any data in the NoSQL database.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

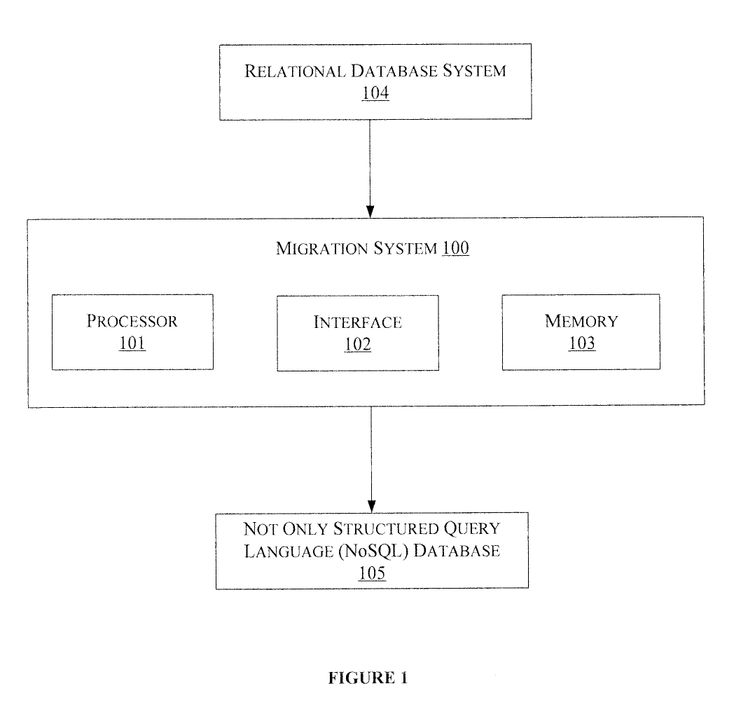

FIG. 1 shows exemplary block diagram illustrating a migration system computing device 100 with processor 101 and memory 103 for migrating data from a relational database to a Not Only Structured Query Language (NoSQL) database in accordance with some embodiments of the present disclosure.

In one implementation, the migration system 100 includes a central processing unit (“CPU” or “processor”) 101, an interface 102 and a memory 103. The processor 101 may comprise at least one data processor for executing program components and computer-readable instructions stored in the memory 103 which is communicatively coupled to the processor 101. The processor 101 is configured for transforming a relational data model into a data model i.e. NoSQL data model of the NoSQL database 105. Also, the processor 101 is configured for migrating the data from the relational database system (i.e. RDBMS) 104 to the NoSQL database 105. The interface 102 is coupled with the processor 101 and Input/Output (I/O) devices (not shown in FIG. 1). The I/O devices retrieve one or more datasets related to database tables from the relational database system 104 through the interface 102. The one or more datasets include, but are not limited to, database metadata information of each of database tables, the query scripts which are used to query the data from each of the database tables, and the query statements which are used for fetching and manipulating the data in the database tables. In an embodiment, a report of transformation of the relational data model to the NoSQL data model of the NoSQL database 105 is transmitted for displaying in the I/O device via the interface 102. Further, results of migration of data from the relational database system 104 to the NoSQL database 105 is transmitted for displaying in the I/O device via the interface 102. The memory 103 may store information which include, but is not limited to, the one or more datasets of each of the database tables of the relational database and the data model including a logical data model and a physical data model of the NoSQL database 105. In an example, the NoSQL database can be Cassandra, HBase, Couchbase, MongoDB Neo4J etc. The Cassandra is a key value columnar database, the Couchbase and MongoDB are a document database and the Neo4J is a graph database.

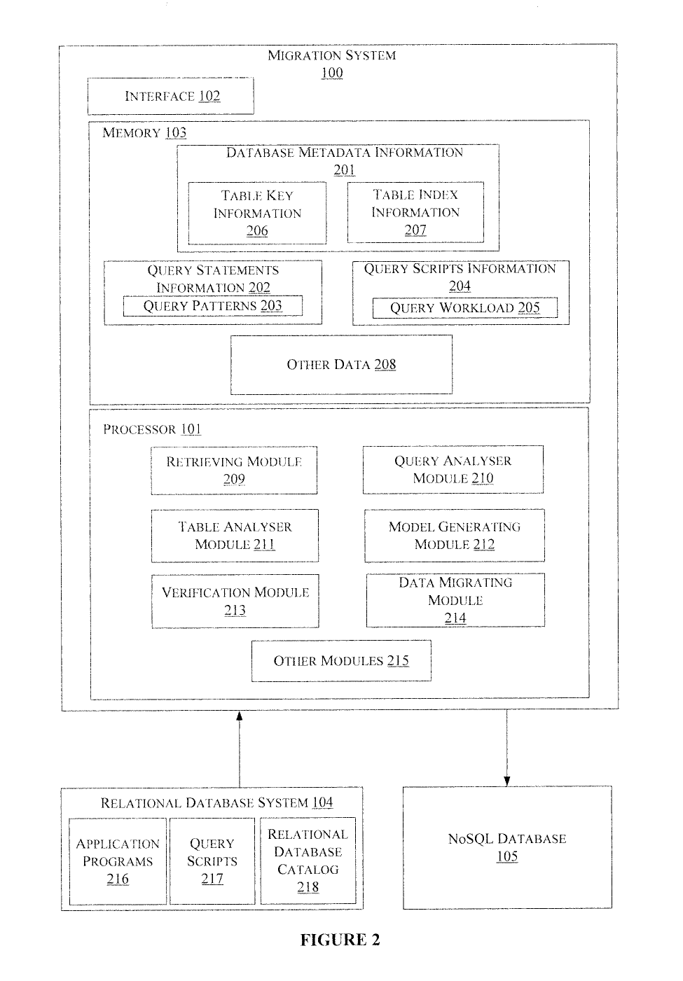

FIG. 2 shows a detailed block diagram illustrating the migration system 100 with various modules for migration data from the relational database system 104 to the NoSQL database 105 in accordance with some embodiments of the present disclosure.

The migration system 100 may be implemented in a variety of computing systems, such as a laptop computer, a desktop computer, a notebook, a workstation, a mainframe computer, a server, a network server, and the like. In an embodiment, the migration system 100 is communicatively connected to the relational database system 219.

The relational database system 104 can be traditional or existing database. The relational database system 104 is known as Relational Database Management Systems (RDBMS). The relational database system 104 is a digital database where the data is organized based on the relational data model. The relational data model organizes the data into one or more tables of rows and columns. Also, the relational data model relates the rows and the columns to one another with a unique key which is assigned for each row. The relational database system 104 is tightly normalized and structured. Usually, virtually, the relational database system 104 uses Structured Query Language (SQL) as the language for querying and maintaining the data. In one implementation, the relational database system 104 comprises one or more data sources (not shown in FIG. 1). The one or more data sources include, but are not limited to, the application programs 216, the query scripts 217 and a relational database catalog 218. The application programs 216 of the relational database system 104 comprises static and/or dynamic query statements i.e. SQL statements. These SQL statements are used to read, update or delete data from the relational database. The query scripts 217 comprise the SQL statements. The query scripts 217 are invoked by a process which includes, but are not limited to, batch process, online process and the like to perform query operations the relational database system 104. The query operations include, but are not limited to, read, update and delete data from the relational database system 104 respectively. The relational database catalog 218 comprises the database tables which contains database metadata information about the relational database system 104.

In an embodiment, information from the one or more data sources of the relational database of the relational database system 104 is used by the migration system 100 for transforming the relational data model into the NoSQL data model of the NoSQL database 105. In one implementation, the information of the relational database from the relational database system 104 is stored in the memory 103. In one implementation, the information of the relational database system 104 may include, for example, database metadata information 201 comprising table key information 206 and table index information 207, query statements information 202, query scripts information 204, and other data 208.

The database metadata information 201 refers to the metadata of each of the database tables of the relational database system 104. The metadata of each of the database tables includes, but is not limited to, entities of the database, tables of the entities, attributes of the tables, columns of the tables, indexes of the tables and the columns, keys of the rows and attributes, fields of the tables, relationships of entities, statistics of indexes, columns which are used for sorting, columns which are used for grouping, constraints of the tables/entities, filters of the tables and the query statements used for the entities. In an embodiment, the database metadata information 201 is retrieved from the relational database catalog 218 of the relational database system 104. In one example, the migration system 100 uses a RDBMS connector to access the database metadata information 201 from the relational database catalog 218 of the relational database system 104. The database metadata information 201 comprises the table key information 206 and the table index information 207 which are explained in later section of the description.

The query statements information 202 of each of the database tables of the relational database system 104 comprises the query statements i.e. SQL statements. In an embodiment, the query statements information of each of the database tables are retrieved from the application programs 216 of the relational database system 104. In an embodiment, the query statements information 202 is used to identify query patterns 203 of each of the database tables of the relational database system 104. The query patterns 203 are used to generate an optimized NoSQL data model based on the application programs 216 which are using critical query statements. In one implementation, the query patterns 203 include, but are not limited to, type of query statements, index of the columns used for the query statements, location from where the columns are accessed, frequency of usage of the columns, aggregation of rows of the tables, ordering of rows which are accessed, correlation between the columns, correlation between the constraints of the tables, volume of data retrieved from the entities, frequency of data usage by the query statements, columns used for grouping the rows, and size of the tables.

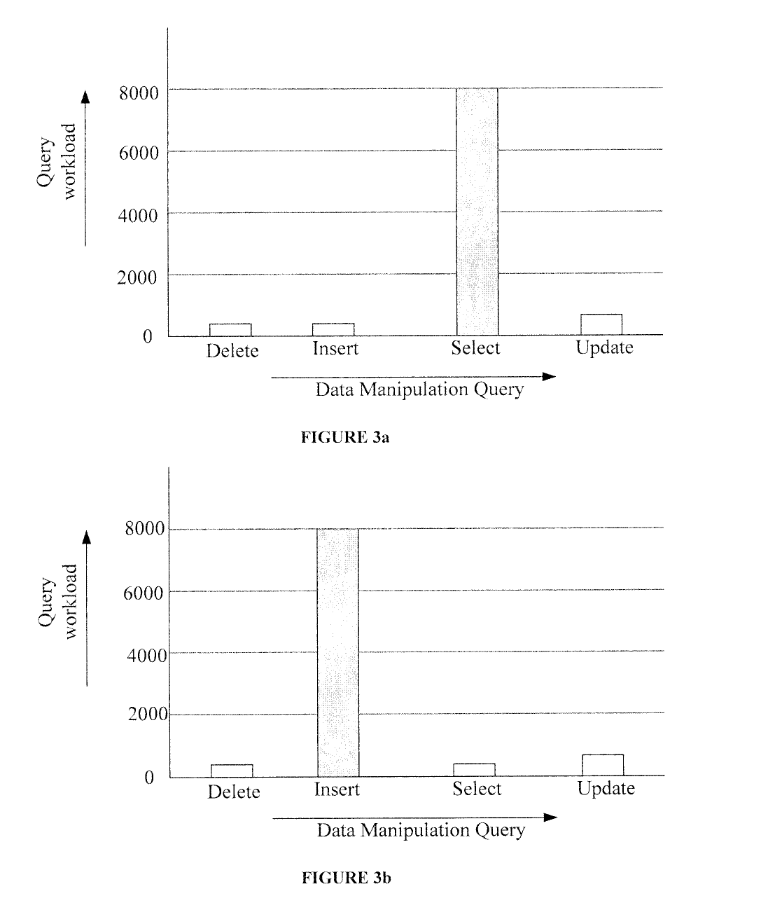

The query scripts information 204 refers to the query scripts which are used for performing the query operations. Particularly, the query scripts information 204 determines type of the query operations performed on each of the database tables of the relational database system 104. The query scripts information 204 is used for identifying query workload 205 which is related to the query operations of each of the database tables. In particular, the query workload 205 defines the type of workload of the query operations. In such a way, the generation of the NoSQL data model is optimized which contains the required type of workload of the query operations. In an embodiment, the query workload 205 comprises type of data manipulation query and frequency of usage of each of the type of data manipulation query. The type of the data manipulation query refers to the type of the query operations performed on the database tables. In an embodiment, the type of the data manipulation query comprises read intensive and write intensive. For example, Data Manipulation Language (DML) activity used in the application programs 216 and/or query scripts 217 defines the type of the data manipulation query. Particularly, the DML activity includes, but is not limited to, “Select”, “Update”, “Insert” or “Delete”. The DML activity “Select” is read intensive as the activity reads data from the relational database system 104. The DML activities “Update”, “Insert” and “Delete” are write intensive as these activities modify the data in the relational database system 104. The DML activity defines the type of the data manipulation query which is in turn related to the type of the query operations. The frequency of usage of each of the type of the data manipulation query refers to number of times the data manipulation query is used. For example, consider “Select” is the data manipulation query used by a user on the database tables of the relational database system 104. FIG. 3a shows the query workload 205 of “Select” data manipulation query which is used for more number of times by the user. In such a case, the migration system 100 generates the NoSQL data model by tuning the NoSQL data model for read performance FIG. 3b shows the query workload 205 on “Insert” data manipulation query which is used for more number of times or frequency by the user. In such a case, the migration system 100 generates the NoSQL data model by tuning the NoSQL data model for write performance The query workload as shown in the FIGS. 3a and 3b respectively is used to recommend one or more factors of the NoSQL database to be used for generating the NoSQL data model. In one example, the one or more factors of the NoSQL database include, but are not limited to, performance tuning parameters such as number of indexes to be used, consistency level to be used and the like.

Referring back to FIG. 2, the table key information 206 refers to metadata information on primary key, composite key, unique key and/or partition key of each of the database tables of the relational database system 104. The table key information 206 is retrieved from the relational database catalog 218 of the relational database system 104. Particularly, the relational database catalog 218 contains information on all indexes of the database tables. The information on the indexes of the database tables includes the primary key, composite key, unique key and/or partition key. In an embodiment, the migration system 100 correlates between the database metadata information 201 of the information of the indexes with the query patterns 203 of corresponding database tables. For example, considering a composite key is determined from the database metadata information 201 of a particular database table. Then, the database metadata information 201 is correlated with the query patterns 203 of the particular database table to determine whether the composite key is used for accessing data from the corresponding database table.

The table index information 207 includes, but is not limited to, clustering key, cluster index, sequence objects of the columns, column attributes which are repeatedly used, index key columns, cluster key columns, column information, and frequency of usage of cluster index columns. The table index information 207 is used for identifying the clustering index for the NoSQL database by using the correlation between the database metadata information 201 and the query patterns 203. The sequence objects of the columns are used to define counter columns and/or unique identified columns in the NoSQL database 105. For example, the sequence objects are converted to the counter columns when the NoSQL database is Cassandra database. In another example, the sequence objects are converted to Universally Unique Identifier (QUID). The table index information 207 comprising the cluster index, the sequence objects of the columns, the column attributes which are repeatedly used are retrieved from the relational database catalog 216 of the relational database system 104.

The other data 208 may be used to store data, including temporary data and temporary files, generated by modules for performing the various functions of the migration system 100. In an embodiment, the information retrieved from the relational database is processed by the modules of the migration system 100. The modules implemented by the processor 101 of the migration system 100.

In one implementation, the modules may include, for example, retrieving module 209, query analyser module 210, table analyser module 211, model generating module 212, verification module 213 and data migrating module 214. The migration system 100 may also comprise other modules 215 to perform various miscellaneous functionalities of the migration system 100. It will be appreciated that such aforementioned modules may be represented as a single module or a combination of different modules.

The retrieving module 209 retrieves the one or more datasets comprising the database metadata information 201, the query statement information 202, and the query scripts information 204 of each of the database tables of the relational database from the relational database system 104. In particular, the retrieving module 209 retrieves the one or more datasets from the application programs 216, the query scripts 217 and the relational database catalog 218 of the relational database system 104.

The query analyser module 210 identifies the query patterns 203 of each of the database tables of the relational database system 104 from the query statements information 202. Further, the query analyser module 210 identifies the query workload 205 of each of the database tables of the relational database system 104 from the query scripts information 204.

The table analyser module 211 determines the table key information 206 and the table index information 207 of each of the database tables. The table analyser module 211 determines the table key information 206 and the table index information 207 based on the correlation between the database metadata information 201 and the query patterns 203 of corresponding database tables. In an embodiment, the table key information 206 and the table index information 207 are determined from the relational database catalog 218.

The data model generating module 212 generates the data model 208 of the NoSQL database 105 by using the database metadata information 201, the query patterns 203, the query workload 205, the table key information 206 and the table index information 207. In an embodiment, the data model generating module 212 performs transformation of the relational database system 104 into the NoSQL database 105. In an example, the data model 208 can be a column family data model, a document oriented data model and a graph database (DB) data model. First, the data model generating module 212 generates the logical data model. In an embodiment, the logical data model comprises one or more information which include, but is not limited to, the database metadata information 201, the query patterns 203 and the table key information 206. In an example, the logical data model comprises entities, columns, attributes for each entity, type of column/attribute, the primary key, the clustering key, and the composite key etc. In an embodiment, the data generating module 212 provides the logical data model for displaying on a user interface (not shown) associated to the migration system 100. In such a way, the user can view the logical data model and can interact to provide updated information to the logical data model. Then, the logical data model 209 is updated based on the updated information provided by the user during the user interaction. Secondly, a physical data model of the NoSQL database 105 is generated by using the logical data model of the NoSQL database 105. The physical data model of the NoSQL database 105 comprises details of data type of columns and attributes, and the table index information. In an embodiment, the physical data model is updated based on the updated logical data model.

The verification module 213 verifies the data model of the NoSQL database 105. In particular, the verification module 213 uses checksum algorithm to verify the presence of the all the relational database tables. In particular, the verification module 213 verifies whether the table key information 206, the details of data type of columns and attributes and the table index information 207 are present in the data model. In an embodiment, the verification module 213 provides an alert to the user interface upon determining the verification to be unsuccessful. For example, if any relational database tables are missed in the data model, then the verification module 213 alerts the user through the user interface.

The data migration module 214 migrates data from the relational database system 104 to the NoSQL database 105. The data from the relational database system 104 is transformed into a format as per the NoSQL data model of the NoSQL database 105. Then, the data from the relational database system 104 is migrated to the NoSQL database 105. In an embodiment, the data migration module 214 verifies whether each of the data present in the relational database system 104 is migrated to the NoSQL database 105. In an embodiment, the data migration module 214 provides intimation to the user interface upon determining missing data in the NoSQL database 105.

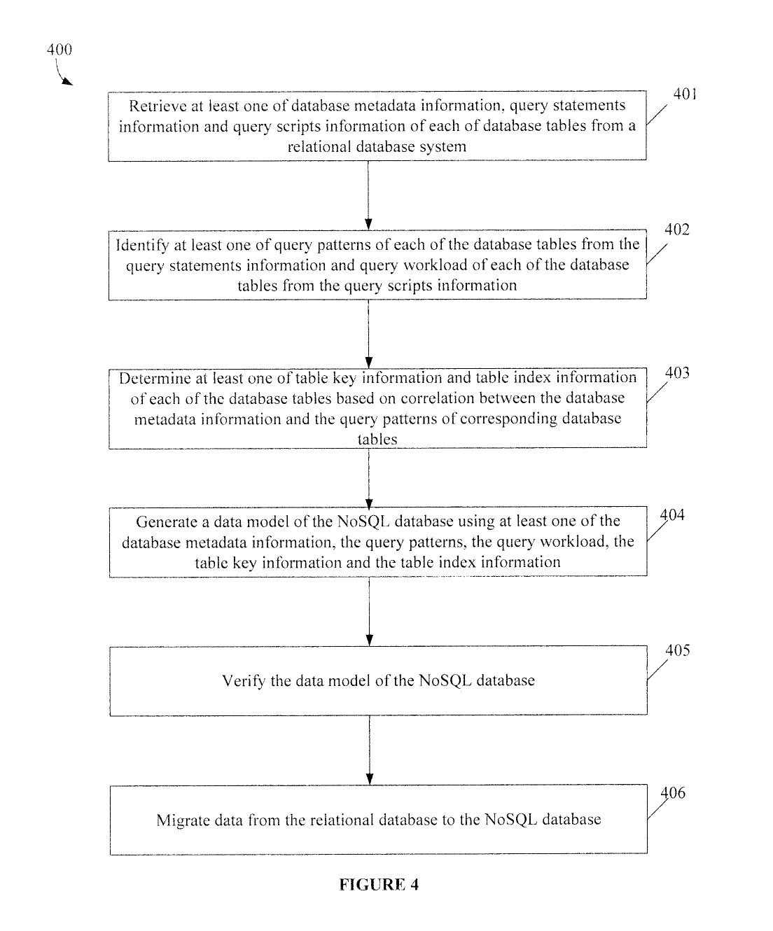

FIG. 4 illustrates a flowchart of method for migrating data from the relational database system 104 to NoSQL database 105 in accordance with an embodiment of the present disclosure.

As illustrated in FIG. 4, the method 400 comprises one or more blocks for migrating the data from the relational database system 104 to the NoSQL database 105 performed by the migration system 100. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method 400. Additionally, individual blocks may be deleted from the method 400 without departing from the scope of the subject matter described herein. Furthermore, the method 400 can be implemented in any suitable hardware, software, firmware, or combination thereof.

At block 401, the migration system 100 retrieves the one or more datasets from the relational database system 104. The one or more datasets comprises the database metadata information 201, the query statements information 202 and the query scripts information 204 of each of database tables from the relational database system 104. In an embodiment, the one or more datasets are retrieved from the one or more data sources of the relational database system 104. The one or more data sources comprise the application programs 216, the query scripts 217 and the relational database catalog 218.

At block 402, the migration system 100 identifies the query patterns 203 of each of database tables from the query statements information 202 and the query workload 205 of each of the database tables from the query scripts information 204. In an embodiment, the query workload 205 comprises the type of data manipulation query which is related to the type of the query operations and the frequency of usage of each of the type of data manipulation query.

At block 403, the migration system 100 determines the table key information 206 and the table index information 207 of each of the database tables based on the correlation between the database metadata information 201 and the query patterns 203 of corresponding database tables. In an embodiment, the table key information 206 refers to the metadata information on the primary key, the composite key, the unique key and the partition key of the indexes of the database tables of the relational database system 104. The table index information 207 refers to the index information which comprises the cluster index, the sequence objects of the columns, the column attributes which are repeatedly used, the index key columns, the cluster key columns, the column information, and the frequency of usage of cluster index columns.

At block 404, the migration system 100 generates the data model of the NoSQL database 105 using the database metadata information 201, the query patterns 203, the query workload 205, the table key information 206 and the table index information 207. In an embodiment, the migration system 100 generates the logical data model which comprises database metadata information 201, the query patterns 203 and the table key information 206. In an embodiment, the migration system 100 provides the logical data model for displaying on the user interface for user interaction. The migration system 100 updates the logical data model based on updated information received from the user during the user interaction. Then, the migration system 100 generates the physical data model using the logical data model, which comprises the details of data type of columns and attributes, and the table index information 207. In an embodiment, the physical data model is updated based on the updated logical data model.

At block 405, the migration system 100 verifies the data model (i.e. NoSQL data model) of the NoSQL database 105. In an embodiment, the migration system 100 verifies the presence of the table key information 206, the details of data type of columns and attributes and the table index information 207 in the data model. In an embodiment, the migration system 100 provides an alert on the user interface upon determining the verification to be unsuccessful.

At block 406, the migration system 100 migrates the data from the relational database system 104 to the NoSQL database 105 upon transforming the data into the format of the NoSQL data model. In an embodiment, the migration system 100 verifies whether all the data from the relational database system 104 to the NoSQL database 105 is migrated. In an embodiment, the migration system 100 provides intimation to the user interface upon missing of the data in the NoSQL database 105.

### Computer System

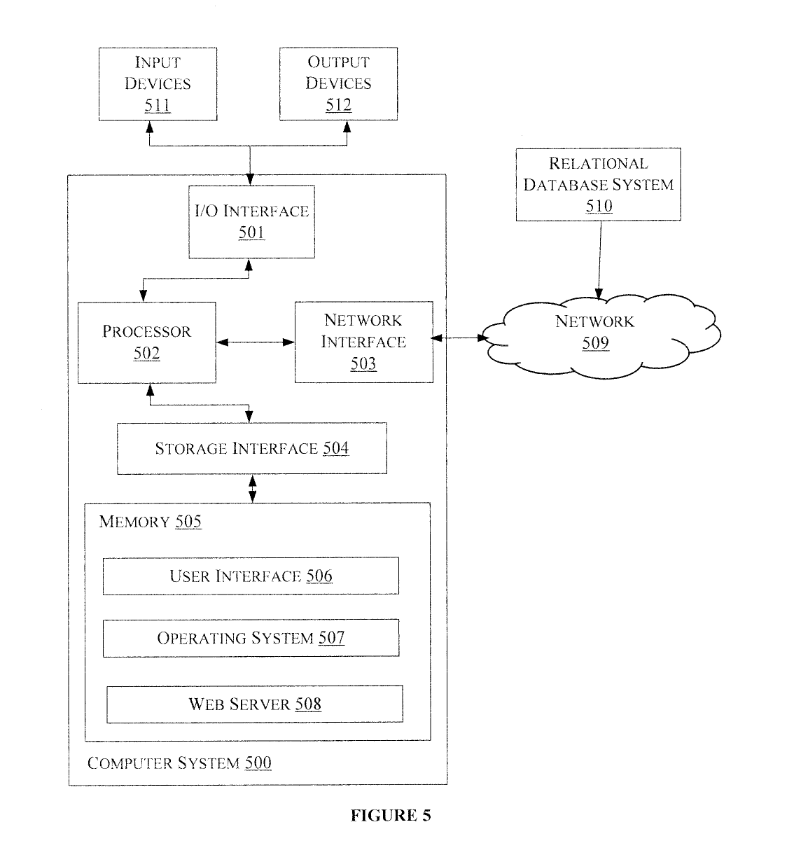

FIG. 5 illustrates a block diagram of an exemplary computer system 500 for implementing embodiments consistent with the present disclosure. In an embodiment, the computer system 500 is used to implement the migration system 100. The migration of the data form the relational database to the NoSQL database is managed by the computer system 500. The computer system 500 may comprise a central processing unit (“CPU” or “processor”) 502. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices (511 and 512). For example, the input device 511 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. The output device 716 may be a printer, fax machine, video display (e.g., cathode ray tube (CRT), liquid crystal display (LCD), light-emitting diode (LED), plasma, or the like), audio speaker, etc.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11 a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with the relational database system 510. The relational database system 500 is a traditional Relational Database Management System (RDBMS).

In some embodiments, the processor 502 may be disposed in communication with a memory 505 (e.g., RAM, ROM, etc. not shown in FIG. 5) via a storage interface 504. The storage interface 504 may connect to memory 705 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 505 may store a collection of program or database components, including, without limitation, user interface application 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 700 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure correlate the metadata information from RDBMS catalog tables and the query patterns in order to generate optimized data model.

Embodiments of the present disclosure used the table key and index information to further optimize in generating the NoSQL data model.

Embodiments of the present disclosure eliminate the manual process transforming the relational database to NoSQL database.

Embodiments of the present disclosure perform verification to confirm whether all the details of the relational database are present in the NoSQL database. In such a way, the data migration is optimized. The verification method reports any missing database objects during migration, which in turn improves quality of migration.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of this technology is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for migrating data from relational databases to Not Only Structured Query Language (NoSQL) databases, the method comprising:
retrieving, by a data migration computing device, at least one of database metadata information, query statements information, or query scripts information of each of a plurality of database tables from a relational database system associated with at least one relational database;
identifying, by the data migration computing device, at least one of query patterns of each of the database tables from the query statements information or a query workload of each of the database tables from the query scripts information;
determining, by the data migration computing device, at least one of table key information or table index information of each of the database tables based on a correlation between the database metadata information and the query patterns of corresponding ones of the database tables;
generating, by the data migration computing device, a data model of a NoSQL database using at least one of the database metadata information, the query patterns, the query workload, the table key information, or the table index information;
verifying, by the data migration computing device, the data model of the NoSQL database; and
migrating, by the data migration computing device, data from the relational database to the NoSQL database.

2. The method as claimed in claim 1, wherein the query workload comprises at least one of a type of a data manipulation query or a frequency of usage of the type of the data manipulation query.

3. The method as claimed in claim 1, wherein:
the table key information comprises a primary key, a composite key, a unique key, or a partition key; and
the table index information comprises a cluster index, a sequence objects of one or more columns, one or more repeatedly used column attributes, one or more index key columns, one or more cluster key columns, column information, or a frequency of usage of one or more cluster index columns.

4. The method as claimed in claim 1, wherein the generating further comprises:
generating a logical data model comprising at least one of the database metadata information, the query patterns, or the table key information; and
generating a physical data model using the logical data model, the physical data model comprising at least one of one or more details of a data type of one or more columns and one or more attributes or the table index information.

5. The method as claimed in claim 4, further comprising updating, by the data migration computing device, at least one of the logical data model or the physical data model based on update information received from a user.

6. The method as claimed in claim 4, wherein the verifying further comprises:
verifying presence of the table key information, the details of the data type of the one or more columns and one or more attributes, and the table index information;
determining when the verification is successful; and
providing an alert when the verification is not determined to be successful.

7. The method as claimed in claim 1, further comprising verifying, by the data migration computing device, migration of the data from the relational database to the NoSQL database.

8. A data migration computing device comprising a processor and a memory coupled to the processor which is configured to be capable of executing programmed instructions comprising and stored in the memory to:
retrieve at least one of database metadata information, query statements information, or query scripts information of each of a plurality of database tables from a relational database system associated with at least one relational database;
identify at least one of query patterns of each of the database tables from the query statements information or a query workload of each of the database tables from the query scripts information;
determine at least one of table key information or table index information of each of the database tables based on a correlation between the database metadata information and the query patterns of corresponding ones of the database tables;
generate a data model of a NoSQL database using at least one of the database metadata information, the query patterns, the query workload, the table key information, or the table index information;
verify the data model of the NoSQL database; and
migrate data from the relational database to the NoSQL database.

9. The data migration computing device as claimed in claim 8, wherein the query workload comprises at least one of a type of a data manipulation query or a frequency of usage of the type of the data manipulation query.

10. The data migration computing device as claimed in claim 8, wherein:
the table key information comprises a primary key, a composite key, a unique key, or a partition key; and
the table index information comprises a cluster index, a sequence objects of one or more columns, one or more repeatedly used column attributes, one or more index key columns, one or more cluster key columns, column information, or a frequency of usage of one or more cluster index columns.

11. The data migration computing device as claimed in claim 8, wherein the processor is further configured to be capable of executing at least one additional programmed instructions comprising and stored in the memory to:
generate a logical data model comprising at least one of the database metadata information, the query patterns, or the table key information; and
generate a physical data model using the logical data model, the physical data model comprising at least one of one or more details of a data type of one or more columns and one or more attributes or the table index information.

12. The data migration computing device as claimed in claim 11, wherein the processor is further configured to be capable of executing at least one additional programmed instructions comprising and stored in the memory to update at least one of the logical data model or the physical data model based on update information received from a user.

13. The data migration computing device as claimed in claim 11, wherein the processor is further configured to be capable of executing at least one additional programmed instructions comprising and stored in the memory to:
verify presence of the table key information, the details of the data type of the one or more columns and one or more attributes, and the table index information;
determine when the verification is successful; and
provide an alert when the verification is not determined to be successful.

14. The data migration computing device as claimed in claim 8, wherein the processor is further configured to be capable of executing at least one additional programmed instructions comprising and stored in the memory to verify migration of the data from the relational database to the NoSQL database.

15. A non-transitory computer readable medium having stored thereon instructions for migrating data from relational databases to Not Only Structured Query Language (NoSQL) databases comprising executable code which when executed by at least one processor, causes the processor to perform steps comprising:
retrieving at least one of database metadata information, query statements information, or query scripts information of each of a plurality of database tables from a relational database system associated with at least one relational database;
identifying at least one of query patterns of each of the database tables from the query statements information or a query workload of each of the database tables from the query scripts information;
determining at least one of table key information or table index information of each of the database tables based on a correlation between the database metadata information and the query patterns of corresponding ones of the database tables;
generating a data model of a NoSQL database using at least one of the database metadata information, the query patterns, the query workload, the table key information, or the table index information;
verifying the data model of the NoSQL database; and
migrating data from the relational database to the NoSQL database.

16. The non-transitory computer readable medium as claimed in claim 15, wherein the query workload comprises at least one of a type of a data manipulation query or a frequency of usage of the type of the data manipulation query.

17. The non-transitory computer readable medium as claimed in claim 15, wherein:
the table key information comprises a primary key, a composite key, a unique key, or a partition key; and
the table index information comprises a cluster index, a sequence objects of one or more columns, one or more repeatedly used column attributes, one or more index key columns, one or more cluster key columns, column information, or a frequency of usage of one or more cluster index columns.

18. The non-transitory computer readable medium as claimed in claim 15, wherein the generating further comprises:
generating a logical data model comprising at least one of the database metadata information, the query patterns, or the table key information; and
generating a physical data model using the logical data model, the physical data model comprising at least one of one or more details of a data type of one or more columns and one or more attributes or the table index information.

19. The non-transitory computer readable medium as claimed in claim 18, further having stored thereon instructions comprising executable code which when executed by the processor further causes the processor to perform at least one additional step comprising updating at least one of the logical data model or the physical data model based on update information received from a user.

20. The non-transitory computer readable medium as claimed in claim 17, wherein the verifying further comprises:
verifying presence of the table key information, the details of the data type of the one or more columns and one or more attributes, and the table index information;
determining when the verification is successful; and
providing an alert when the verification is not determined to be successful.

21. The non-transitory computer readable medium as claimed in claim 15, further having stored thereon instructions comprising executable code which when executed by the processor further causes the processor to perform at least one additional step comprising verifying migration of the data from the relational database to the NoSQL database.
